(19) United States
(12) Patent Application Publication
(10) Pub. No.: US 2009/0167863 A1
(43) Pub. Date: Jul. 2, 2009

(54) Blackbody radiation referenced image capture of a moving object having transient light interference

(76) Inventor: William Ralph Jones, JR., Oakland Park, FL (US)

Correspondence Address: William Ralph Jones Jr., PO. Box 23609, Oakland Park, FL, 33307-3609, US

(21) Appl. No.: 12/317,380

(22) Filed: Dec. 22, 2008

Related U.S. Application Data
(60) Provisional application No. 61/009,437, filed on Dec. 31, 2007.

(51) Int. Cl. H04N 7/18

(52) U.S. Cl. 348/143; 348/E07.085

(57) ABSTRACT

A stroboscopic system for the purpose of capturing an image of a rapidly moving scene under low-light conditions but having widely varying interfering ambent light sources present, which sources vary with each video frame captured. The system includes a referencing method which removes the effects of the ambient light that would otherwise overlap the features of interest of the image being captured and would otherwise act to obscure the image.

### DESCRIPTION OF THE INVENTION

The present invention is aimed at, but not restricted to, use for law enforcement purposes by capturing video images of evidentiary features of rapidly passing objects, such as motor vehicles. Some such features are license plate numbers of automobiles and the faces of their drivers, or the faces of running suspects.

Systems exist for the capture, stroboscopically, of automobile tags. They mostly take advantage of the fact that most if not all states require all tags to be coated with a retroreflective material, which reflects light preferentially back in the direction from which it came. This feature makes license tags extremely visible to a viewer near a light source, such as a police officer in a patrol car with its headlights on. It also enables the use of LIDAR speed determination while keeping the power of the LASER source therein at safe levels.

In the area of license tag image capture, systems operated in the daytime need be very simple indeed, since nearly any modern video camera will operate at exposure times of 1/10,000 to 1/100,000 second, fast enough to freeze the motion of a tag on a moving vehicle and to allow the capture of the tag number. Under low lighting conditions, however, short and fairly intense pulses of light are used. These pulses are synchronized with the vertical synchronization pulse of the acquiring camera and, even though the camera may automatically set its own exposure time to up to 1/60 second, which would usually render a tag number too blurry to recognize, under low light conditions the optical aperture of the camera can be closed to the point that it does not register most of the ambient light and, during a the synchronized flash, all of the light required to form an image is acquired. Thus freezing the motion of the vehicle and its tag are accomplished at night.

However, this method rejects only true ambient conditions such as background from street lights or porch lights nearby. Another source of ambient light exists, a transient source. That source is the tag light legally required on each vehicle. The intensity of tag lights, usually incandescent lamps, varies from burned out through extremely bright and all the way to a dislodged and directly exposed incandescent bulb that is lighted. Setting up a system that rejects this source of transient light through the use of optical filtering in the image forming path is partly successful, as is using different lens iris settings for day and night capture.

This invention adds another tool for the rejection of transient but unwanted light.

Since most tag lights are incandescent, and will remain so for decades to come, they emit light in a well-defined spectral pattern, governed by the well-known laws of blackbody radiation. In this invention, the scene of interest is illuminated by a bright, short pulsed light source of known spectral content, an example of which is a pulsed LED array. The spectral characteristics of the transient ambient light are different from those of the LED array, and a standard color video camera can distinguish what image came from what source.

In this invention, the camera and light arrangement capture, synchronously with the camera's vertical synchronization pulse, a color image of the passing automobile tag. The tag will appear as a spatially frozen plate with numbers on it, superimposed on any transient ambient tag lighting that exists on the vehicle. The image can then be scanned, pixel by pixel, by computer, to inspect the ratios of spectral colors present at two or more different wavelengths, one being that of the strobing LED. An example of an algorithm, which by no means is the only obvious one, is to look for ratios of red to green, red to blue, and blue to green, and compare them to what the ratios of an incandescent light should be. If these ratios are within limits and are correct, an incandescent intensity can be estimated for that pixel. These are simple calculations that can be done in real-time using a microcontroller. If there is an excess of the LEDs color in the pixel, then that excess can be subtracted out and, again, an incandescent background intensity can be estimated. Each time such intensity is estimated, it is subtracted from each color value for that pixel, in ratios according to the laws governing blackbody radiation, for that overall pixel. Within the limits of the camera system's signal-to-noise performance, the result will be an elimination of the incandescent portion of the pixel's intensity but not the LED source's portion. This will approximate an image that would be had in the ideal situation, which is a tag on an automobile without any tag light at all.

### PREFERRED EMBODIMENT OF THE INVENTION

A preferred embodiment of this invention, as partly described above, is a device for capturing images of passing automobile license tags, particularly at night, in the presence of interfering ambient light that is transient and unpredictable in intensity and in spatial position with respect to the tag itself.

It is well known that pulsed lighting may be synchronized with the vertical synchronization pulses from video cameras, thus lighting a scene for a very short time during each video frame and thus freezing the motion of the a passing object in its view, and thus eliminating the blur from the image that would have been caused by allowing a continuous light source to illuminate the passing object.

However, in the case of a passing automobile tag, there is a type of ambient lighting that is required by law, the tag light. Many people do not pay much attention to this small light source, and the variation in the condition and characteristics of this light source can be extreme. Some cars have no working tag lights at all. Some have one of two of their lights working. Some have lights that illuminate the tag from a different angle than others. Some have working tag lights that are dislodged from their original mountings and whose bare light bulbs can be directly viewed by the camera.

In the preferred embodiment of this invention, a pulsed LED light source is aimed at the area where the tag capture camera is pointed. The camera is a color video camera, which produces a red, a blue, and a green representation of the passing tag and whatever is in its view during the exposure time, which, at night, can be as long as 1/60 second. Normally this set of images is combined into a composite video signal from which the red, blue, and green images may be reconstructed electronically, but some cameras may output separate red, blue, and green signals along with synchronization signals. However the camera formats its output, in this invention the signal must be put in the form of an array of red pixels, and array of blue pixels, and an array of green pixels which if overlaid in alignment, would produce a color image of the scene in that image.

When a car passes, one thing that can happen is that an image of the tag appears, mostly clearly, in the color rendered by the color of the light being used as pulsed illumination. This image exists along with any image elements produced by ambient light, such as reflections from street lights, which is a very infrequent source, and streaks made by the incandescently lighted lamps during the long exposure times required at night and an image of the tag itself smeared and unreadable, that overlaps the clear strobed picture of the tag. When the incandescent lighting is very bright, the smeared image overwhelms the differently colored non-smeared image, making it difficult to identify the numbers on the tag. When the incandescent lamps themselves move across the image of the tag during the long exposure time, they cause bright streaks across the tag that obliterate the identifying information on the strobed image of the tag.

It turns out that, since the tag is being illuminated by light sources that have differing spectral characteristics, they can be distinguished. If the systems takes the red, blue, and green arrays of pixels generated for the image of the tag, with interference and all, and inspects it on a pixel-by-pixel basis, the digitized values of red, blue and green intensities can be compared. Since the most frequent interfering light source is incandescent, the ratios of the red to blue and red to green are fixed and defined by the physical laws governing the spectral content of radiating blackbodies. If the image is being acquired by attempting to use a red strobed source, for example, any pixel that was aimed at a completely dark spot on the image will show all zeros, to within noise. Any pixel that was aimed at a spot on the image that would have been completely dark except for the presence, during exposure, of a feature of the passing vehicle that was illuminated significantly only by the incandescent tag light, will have characteristic red/blue and red/green ratios. However, any pixel that was aimed at a spot that returned significant illumination that originated from the strobed red source will, even if it also contains interfering illumination from the incandescent tag light, contain an excess of red illumination.

In the last case, the digitized value of the expected red pixel can be estimated, to within noise, from the intensities of the blue and/or green values. This estimated red value can then be subtracted, for that pixel, from the actual digitized value of the pixel, thus subtracting out the effects of the interfering incandescent light.

There will be cases in which the interfering light saturates all of the color values in a particular pixel, and in this case the technique will not work. But for the most part the pixel values will not be saturated, and the images of the identifying numbers and letters on the license tag will be enhanced, making much more of the image useable, and rendering what would have been an obscured identifying feature identifiable.

This correction requires two divisions and a compare operation per pixel, and then a subtraction operation. Today's inexpensive Digital Signal Processors (DSPs) are capable of doing all these operations at a rate fast enough to present a corrected image without any perceivable delay, and certainly without having to miss any pixels to make up for lost time.

### PRIOR ART

U.S. Pat. No. 6,178,254 describes a multicolor and multipixel acquisition device followed by processing by computer in its claims. It in fact describes a method, in one claim, for subtracting an expected color level from a multipixel representation of an image to find features that would otherwise be hidden. However, all claims in this prior art specify that their algorithmic methods are for the purpose of monitoring color quality test patches on printing press webs. The present invention makes a different sort of multicolor measurement and is intended for more general use.

U.S. Pat. No. 6,989,859 requires a reference to an ambient light level in its first claims. In its last claim, it requires reference to known “color temperature” values. The present invention neither requires either feature nor uses either feature.

U.S. Pat. No. 5,365,084 is also designed to view a moving printing web, or, more generously, a moving scene, inspecting it by the use of controlled illumination partly for the purpose of freezing motion and partly for the purpose of inspecting the scene in a plurality of spectral colors to allow analysis. It does not, however, in any of its claims, attempt to control for ambient light, that is to say, light that is detected but not generated by the system intentionally. The present invention has compensation for a wide variety of unpredictable ambient light as its central theme.

U.S. Pat. No. 4,794,453 describes a video camera that is synchronized to an unpredictably occurring event, along with lighting similarly synchronized. It does not described a free-running camera that has any sort of colored pulsed light synchronized to itself. The present invention, while it could be operated asynchronously, is intended to synchronize a pulsed light source with a free-running camera and to aim that light source at the scene at which the camera is aimed.

What I claim is:

1. A system comprised of a color video camera, the vertical synchronization pulse of which triggers the emission of a short, motion-freezing light pulse that illuminates the scene at which said camera views, and which uses the known spectral characteristics of an interfering but unpredictably occurring transient ambient light source in order to mathematically correct for and essentially remove said interference, yielding a clear, frozen image under all ambient lighting conditions, and yielding real-time video signals representing said corrected images.

2. A system, as in claim 1, in which the pulsed light source is an LED or an LED array of any color, or a plurality of LEDs or LED arrays having different colors.

3. A system, as in claim 1, in which the pulsed light source is comprised of any other commonly known light source that can be operated in a short-pulsed mode and whose spectral content is known.

4. A system, as in claim 1, in which the light source is located in close proximity to the camera and pointed in the same direction as is the camera for optimal capture of retroreflective objects.

5. A system, as in claim 4, in which said retroreflective objects are motor vehicle license tags.

6. A system, as in claim 1, in which the object of interest is the face of a person inside a passing motor vehicle.

7. A system, as in claim 6, in which the interfering transient ambient light source is a fixed source of known spectral characteristics and that may reflect from automobile windows to cause interference.

8. A system, as in claim 6, in which the interfering transient ambient light source is anticipated to have known spectral characteristics and which travels along with the vehicle to cause interference, such as an interior incandescent light.

9. A system, as in claim 1, wherein the light sensitive device is, rather than a standard color video camera sensitive to the three primary colors red, blue, and green, is instead a specialized video camera based upon a sensor array designed to be sensitive to other colors or wavelengths of light, whether visible or invisible to the human eye.
